(19) United States
(12) Patent Application Publication
(10) Pub. No.: US 2009/0235006 A1
(43) Pub. Date: Sep. 17, 2009

(54) Baby Monitoring System with a Receiver Docking Station

(75) Inventors: Craig Desrosiers, Spring City, PA (US); Jeffrey Swan, West Chester, PA (US)

Correspondence Address: LEMPIA BRAIDWOOD LLC, 223 W. JACKSON BLVD., SUITE 620, CHICAGO, IL, 60606, US

(73) Assignee: Graco Children's Products Inc., Exton, PA (US)

(21) Appl. No.: 12/047,308

(22) Filed: Mar. 12, 2008

(51) Int. Cl. G06F 13/00

(52) U.S. Cl. 710/304

(57) ABSTRACT

A child monitoring system includes a transmitter configured to capture information and transmit a signal indicative of the captured information, and a receiver configured to receive the signal and to generate an output in accordance with the captured information. The receiver includes a portable unit and a docking station configured to engage the portable unit. The receiver includes a detector configured to determine whether the portable unit and the docking station are engaged. The receiver includes a processor configured to control generation of the output in accordance with whether the portable unit and the docking station are engaged.

### BACKGROUND OF THE DISCLOSURE

1. Field of the Disclosure

The present disclosure is generally directed to baby or child monitoring systems, and more particularly to baby monitoring systems having a mobile or portable unit.

2. Description of Related Art

Monitoring systems for babies or other children typically include a parent (or receiver) unit designed to receive signals transmitted from a child (or transmitting) unit. Sounds captured by the child unit are then reproduced by the parent unit for monitoring by a parent. If the parent wishes to move about the home and continue to monitor the child, the parent must either stay near the parent unit or carry the parent unit with them.

Most parent units can operate under battery power to help the parent place the parent unit in a convenient location. Some baby monitors include rechargeable batteries in the parent unit. Some of these systems, in turn, also include a docking station that provides a location to conveniently store the parent unit and recharge the batteries. The Graco 2791 DIG and the Philips SCD590 monitor systems are examples of baby monitoring systems that include rechargeable batteries in the parent unit, and a docking station to recharge the batteries.

Despite the convenience of battery operation, parent units in baby monitor systems have usually not readily lent themselves to being carried. In the past, many parent units have had a relatively large housing to support an antenna projecting outward from the housing. The large size of the parent unit has often been accompanied by a cumbersome shape.

A number of baby monitoring system providers have attempted to address this issue by providing a belt clip as an integral part of the parent unit housing. However, the size of conventional parent units makes wearing these products relatively, and sometimes extremely, uncomfortable. This can be particularly true if the parent wishes to do tasks or chores that require frequent bending, sitting, and standing. If a parent clips the unit to their belt or waistband and moves about in such a manner, the device can cause discomfort. Thus, a parent may either choose to leave the parent unit behind and not be able to continuously monitor their child or choose not to do the intended tasks or chores.

### BRIEF DESCRIPTION OF THE DRAWINGS

Objects, features, and advantages of the present invention will become apparent upon reading the following description in conjunction with the drawing figures, in which common elements are identified with like reference numerals, and in which:

FIG. 1 is a perspective view of an exemplary baby monitoring system having a transmitter configured for communication with a receiver having a portable unit and a docking station with which the portable unit can be engaged;

FIGS. 2A and 2B are perspective, side views of the portable unit of the receiver shown in FIG. 1;

FIG. 3 is a block diagram schematically depicting an exemplary baby monitoring system in which a receiver includes a portable unit with vibration alert functionality based on whether the portable unit is engaged with a speaker-equipped docking station and in accordance with one aspect of the disclosure;

FIG. 4 is a block diagram schematically depicting an exemplary baby monitoring system in which a receiver includes a portable unit with soundlight dimming functionality based on whether the portable unit is engaged with a docking station and in accordance with one aspect of the disclosure;

FIG. 5 is a block diagram schematically depicting an exemplary baby monitoring system in which a receiver includes a portable unit with soundlight dimming functionality based on whether the portable unit is engaged with a docking station having a light sensor in accordance with another aspect of the disclosure;

FIGS. 6-11 are block diagrams schematically depicting exemplary baby monitoring systems in which audio reproduction functionality of a receiver is distributed between a portable unit and a docking station based on whether the portable unit is engaged with a docking station and in accordance with one aspect of the disclosure;

FIG. 12 is a block diagram schematically depicting an exemplary baby monitoring system in which soundlight functionality of a receiver is distributed between a portable unit and a docking station based on whether the portable unit is engaged with a docking station and in accordance with one aspect of the disclosure; and,

FIGS. 13-15 are block diagrams schematically depicting exemplary baby monitoring systems in which video reproduction functionality of a receiver is distributed between a portable unit and a docking station based on whether the portable unit is engaged with a docking station and in accordance with one aspect of the disclosure.

### DETAILED DESCRIPTION OF THE DISCLOSURE

The disclosure is generally directed to baby monitoring systems in which receiver functionality is provided by a portable parent unit. To increase portability and mobility, the systems described herein include very small size parent units. The reductions in the size of the parent unit, however, can compromise the quality or effectiveness of features or functionality. For instance, a speaker may be physically smaller and difficult to hear when the unit is not close to the user. Soundlights may also be smaller, or reduced to only a single light. These compromises may be acceptable during occasional use, but some users may not find the limited functionality optimal in all situations.

To address these challenges, the baby monitoring systems described herein include a receiver docking station configured to provide receiver output functionality that may or may not be also provided on a portable receiver unit. The receiver functionality may involve a variety of different output types, including, for examples soundlights, vibration alerts, audio reproduction, video reproduction, or any combination thereof. In some aspects, the disclosure is generally directed to disabling, enabling, modifying or otherwise controlling one or more of these output functions in accordance with whether the portable unit is engaged with the docking station. For instance, a particular function available via the portable unit may be disabled upon engagement with the docking station, at which point the functionality of the docking station may take over. In other cases, a portable unit function may be disabled to avoid complications that would arise if the function were to be implemented while the portable unit was docked. In still other cases, the docking station may provide a function enabled by the engagement that is not separately available via the portable unit due to, for instance, its small size.

Although described in connection with exemplary baby monitor systems involving the capture of audio or image data for a caregiver, the disclosed techniques, devices and systems are well suited for implementation and use in a variety of contexts and applications. Practice of the disclosed techniques, devices and systems is accordingly not limited to a particular child monitoring context or application.

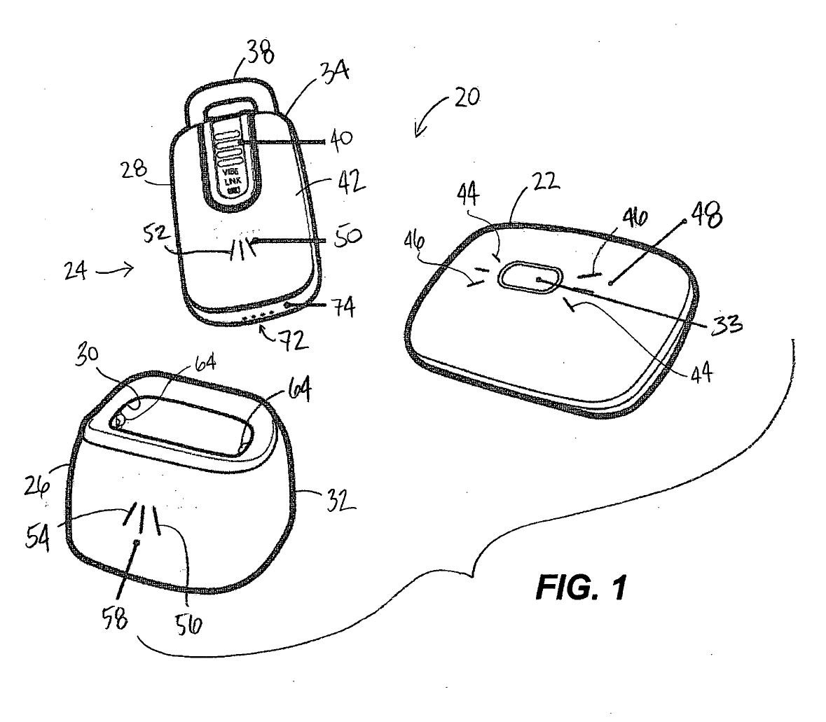

Turning now to the drawings, FIG. 1 shows one example of a monitor system indicated generally at 20. In this example, the monitor system 20 includes one child unit or transmitter 22 and one parent receiver indicated generally at 24. The transmitter 22 and the receiver 24 are generally configured for communication to support the transfer of information captured at the location of the transmitter 22, e.g., a nursery. To that end, the transmitter 22 is generally configured to transmit an RF or other wireless signal carrying the captured information via any desired modulation or other communication protocol. The receiver 24 is generally configured to gather the transmitted signal to extract the information.

In accordance with one aspect of the disclosure, the parent receiver 24 includes a docking station 26 and a portable unit 28. The portable unit 28 is generally configured to be received or otherwise engaged by the docking station 26 when not being worn or carried by a user. In this example, the docking station 26 includes a cradle 30 formed in a base housing 32 and shaped to accept the portable unit 28 when inserted in an upright orientation. However, the orientation and manner of engagement of the docking station 26 and the portable unit 28 may vary considerably, as desired. The shape and form of the cradle 30 and the base housing 32 may also vary considerably to accommodate a variety of different shapes and sizes for the portable unit 28. Generally speaking, the docking station 26 can be formed as any type or form of base or stand to present a stand, bed or other platform on which the portable unit 28 can be mounted or to which the portable unit 28 can be engaged.

Though not shown herein, the monitoring system 20 may include one or more of the transmitters, one or more of the receivers, and a number of system accessories including AC to DC power converters for the units, rechargeable battery packs, and the like. The transmitters and receivers of the system 20 may, but need not, be of similar size, shape or form. For instance, some receivers may not be configured for engagement with a docking station. Some transmitters may be configured to rest on a nightstand or other item in a nursery or bedroom, while others may include accessories for a wall-mount or other configuration. In either case, one or more of the transmitters may be configured to provide a light or other user interface element to indicate its operational status. In some cases, the light may be configured as a nightlight 33, as shown in the example of FIG. 1.

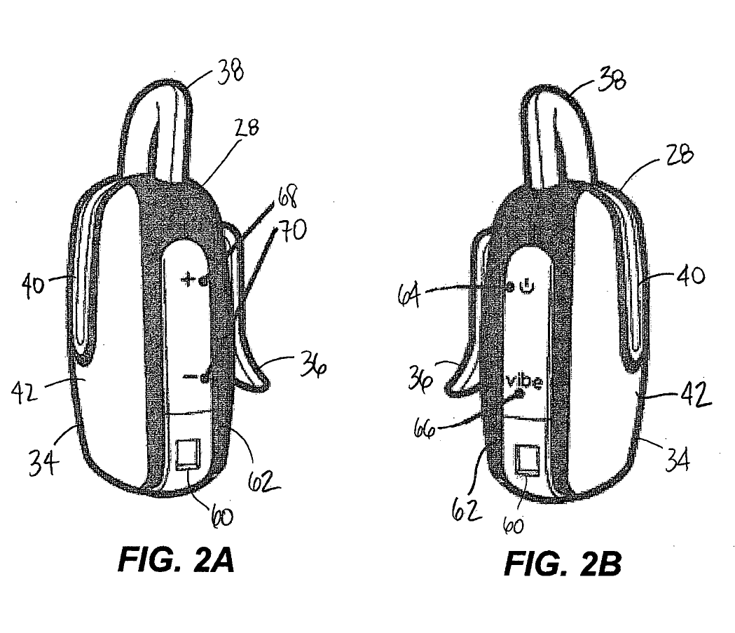

A housing 34 of the portable unit 28 generally has a small or compact size. As shown in FIGS. 2A and 2B, the housing 28 may also have a slim profile for placement in a pocket, for carrying on a belt via a clip 36, or to otherwise facilitate portability. In these ways, the housing 28 may be considered a handheld or pocket size unit. The portable unit 28 may also be wearable in a variety of ways through engagement of a loop 38 extending from the housing 34.

Despite its small size, the portable unit 28 includes a user interface panel 40 on a front face 42. In this example, the user interface panel 40 includes a set of soundlights and other visual indicators of operational status. Each soundlight may include any type of light, lamp, or illumination device, including, for instance, a light-emitting diode (LED). In this example, one of the status indicators may be illuminated to indicate that a vibration feature is enabled or activated, while another may be used to indicate the status or quality of the communication link with the transmitter 22.

In operation, the portable unit 28 generally reproduces audio, image or video information captured by the transmitter 22. In this audio monitoring example, the transmitter 22 includes one or more microphones (or other sound transducers) 44 located near or behind apertures 46 in a cover 48. The portable unit 28 accordingly includes a speaker 50 located near or behind apertures 52 in the front face 42 of the housing 34 to reproduce audio information captured by the microphone 44. In this way, the monitoring system 20 can be used to monitor the sounds in a nursery or other location of the transmitter 22.

In accordance with one aspect of the disclosure, the docking station 26 of the receiver 24 also includes a speaker 54 located near or behind apertures 56 in a front face 58 of the base housing 32. Generally speaking, the audio reproduction functionality of the receiver 24 is shared between the docking station 26 and the portable unit 28 in accordance with whether the portable unit 28 is engaged with the docking station 26. In this example, when detached from the docking station 26, the speaker 50 of the portable unit 28 is directed to reproduce the captured sounds. When the engagement of the docking station 26 and the portable unit 28 is detected, then the speaker 54 of the docking station 26 is instead directed to reproduce the captured sounds. In some cases, and as described further herein, the docking station 26 may be configured to provide audio (or sound) reproduction even when the portable unit 28 is not engaged. To that end, a user select switch or other setting may be provided.

As shown in FIGS. 2A and 2B, the housing 34 of the portable unit 28 may include a pair of depressions 60 on respective side faces 62 to facilitate the engagement with the docking station 26. The depressions 60 may be located on the faces 62 at a position and level that matches corresponding projections 64 (FIG. 1) extending from interior walls of the cradle 30. The projections 64 are generally deformable or deflectable to allow the portable unit 28 to enter the interior space defined by the cradle 30. In this example, each projection 64 includes a resilient strip, although a variety of different springs and other structures may alternatively be used to form a desired press-fit or other engagement. The side faces 62 of the portable unit 28 may also include further user interface elements, such as a power ON/OFF button or toggle switch 64, a vibration alert ON/OFF button or toggle switch 66, and up/down volume adjustment buttons 68, 70.

The docking station 26 serves as a power source for the portable unit 28. To that end, the docking station 26 and the portable unit 28 include electrical connection interfaces. In this example, a connection interface 72 of the portable unit 28 is disposed on a bottom face 74 of the housing 34, as shown in FIG. 1. The connection interface 72 and the corresponding interface of the docking station 26 may be configured, for instance, as a matching pair of male/female connectors or in a variety of other complementary ways. In this case, the connection interface 72 includes a set of receptacles configured to receive a corresponding number of pins or probes extending into the interior space of the cradle 30 of the docking station 26. In some cases, one or more of the pins may be pogo pins to minimize the surface area for the connection interface while establishing high-quality electrical connections. The quality of the electrical connections may be useful for maintaining clear transmission of data, such as the captured information received from the transmitter 22. Thus, in some cases, the connection interface supports data transfer in addition to the power delivery function.

As described below, the monitoring system 20 is generally configured to support a broad range of functionality despite the small size of the portable unit 28. A number of examples are set forth to describe how the interactive combination of the portable unit 28 and the docking station 26 supports a number of different functions, features and capabilities. Although described separately, the examples are set forth with the understanding that alternative embodiments may include or incorporate any combination of the functions, features, or capabilities of the examples to any desired extent.

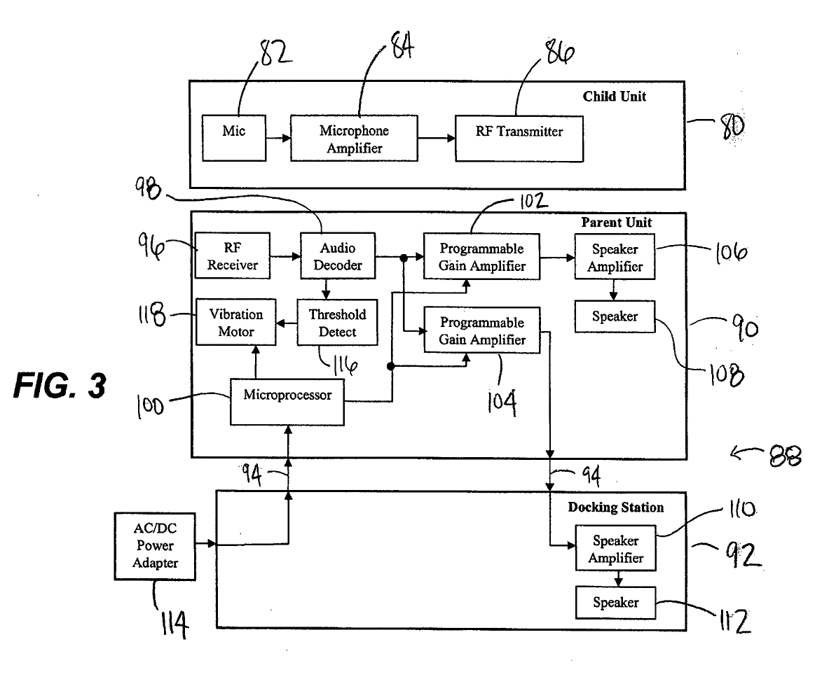

With reference now to FIG. 3, an exemplary transmitter or child unit 80 includes a number of analog or digital components to capture sounds and generate audio data for transmission. At the outset, the sounds encountered in the nursery or other monitoring location are converted to electrical energy with a microphone transducer 82. The resulting analog signal is amplified with a microphone amplifier 84. In some cases, the analog signal may then be converted to digital data by an analog-to-digital converter (not shown). In any case, the data is eventually processed for incorporation into a wireless signal. In the example shown, the analog representation of the captured information is sent directly to RF transmitter electronics 86 for encoding (or modulating) an RF transmission (e.g., a 900 MHz or 2.4 GHz carrier signal) with the audio information. The electronics 86 are thus configured for generation of an RF signal provided to a transmission antenna (not shown) configured for wireless propagation of the RF signal.

In other cases, a microprocessor (not shown) in the transmitter 80 may be used to prepare a digital representation of the captured information, while other child units may utilize any one or more of a variety of processing units, such as an application specific integrated circuit (ASIC), digital signal processor, etc. The processing may involve or implement any one or more techniques to support the digital transmission of the audio data, such as compression, encryption, organization into a data stream of packets, etc. The processing may also include or involve analysis or other procedures directed to the generation and incorporation of additional information or data, such as alerts and other commands, to be transmitted as part of the digital data stream with the audio data.

Reception of the wireless signal and processing of the transmission by a receiver indicated generally at 88 are now described. As a general matter, the receiver 88 is configured to receive the wireless signal to generate, or reproduce, the sounds captured by the transmitter 80, as well as act on any commands, alerts or other information received via the transmitted signal. More specifically, the receiver 88 includes a portable unit 90 and a docking station 92 to which the portable unit 90 is coupled via electrical connections or contacts 94. In this example, the wireless signal is received by an antenna or other apparatus (not shown) coupled to RF receiver electronics 96 in the portable unit 90, which may decode, demodulate and otherwise process the wireless signal to derive (e.g., reconstruct or generate) the transmitted audio information. To that end, the portable unit 90 may include a decoder or demodulator 98 integrated with other components of the portable unit 90 to any desired extent. In alternative embodiments, further demodulation, decompression and other processing techniques may be implemented by a microprocessor coupled to the RF receiver electronics 96. For example, a microprocessor, processor, or other controller may parse and otherwise process a digital data stream to determine, for instance, which portions of the data stream are representative of audio data.

The example shown in FIG. 3 includes a microprocessor 100 for controlling audio reproduction and other functionality. An analog waveform or other representation of the captured sounds is provided to a pair of programmable gain amplifiers 102, 104 controlled by the microprocessor 100. The amplifier 102 provides an input signal at a desired amplitude level to a speaker amplifier 106 for a speaker 108 of the portable unit 90. In this way, the speaker amplifier 106 drives the output of the speaker 108 at a volume level selected for the portable unit's reproduction of the captured sounds. In this example, the programmable gain amplifier 104 provides a separate audio waveform to a speaker amplifier 110 for a speaker 112 of the docking station 92. In this way, the volume levels for the sound reproduction by the portable unit 90 and the docking station 92 may be controlled separately by the microprocessor 100 via the programmable gain amplifiers 102, 104. To these ends, the microprocessor 100 may be responsive to one or more user switches or settings (not shown) to adjust the volume levels or for speaker activation and deactivation. As described below, the audio reproduction of the captured sounds may be distributed between the speakers 108, 112 based on whether the portable unit 90 and the docking station 92 are engaged. The microprocessor 100 and, more generally, the remainder of the portable unit 90 and any rechargeable batteries thereof, may receive DC power from a power adapter 114 via the connectors or contacts 94.

The decoded audio information is analyzed by a threshold detect comparison or logic 116 that may, but need not, be provided by or otherwise involve the microprocessor 100. Whether analog or digital, the threshold comparison or logic 116 is generally configured such that, when the amplitude of the captured audio exceeds a threshold, a vibration motor 118 is actuated. In this way, a caregiver can be alerted to loud sounds in the nursery without having to resort to, or rely on, the audio reproduction.

In accordance with one aspect of the disclosure, the microprocessor 100 is configured to enable and disable the vibration alert functionality based on whether the portable unit 90 and the docking station 92 are engaged. More specifically, the microprocessor 100 is configured to detect when the portable unit 90 is inserted into the docking station 92. In this example, the microprocessor 100 implements a detection routine configured to look for a charging voltage from the docking station 92. To that end, an input port or pin of the microprocessor 100 may be coupled to the line carrying the charging voltage, thereby forming part of the detection mechanism. When the charging voltage is detected, the microprocessor 100 disables the vibration motor 118 from actuating. The manner in which the vibration motor 118 is disabled may vary considerably. In some cases, the vibration motor 118 may include a switch or other control element responsive to a command signal from the microprocessor 100. Alternatively, the threshold comparison or logic 116 may be configured to be responsive to a signal from the microprocessor 116.

The dock engagement detector may be provided in a variety of ways. Alternative detection techniques need not involve the microprocessor 100. For example, other techniques may rely on the presence or absence of the charging voltage, but utilize or involve a detector device or detection logic provided by a different processing element, controller or other electronics component of the receiver. For example, a transistor-based circuit may be coupled to the charging voltage line and configured to generate a digital output representative thereof. In some cases, such circuitry or logic may be integrated with the microprocessor 100 to any desired extent. Other suitable detection schemes need not involve the charging voltage, but rather include or involve a mechanical switch or other mechanical assembly displaced via the engagement. In one example, the displacement of the projections 64 on the portable unit housing 34 may, in turn, lead to a switch that changes states based on the engagement. Still other examples may include or involve any one of a variety of conventional proximity sensors (electromagnetic, magnetic, etc.) configured to detect when the portable unit and the docking station are engaged.

Generally speaking, the control of the vibration alert functionality prevents the portable unit 90 from vibrating while residing in the docking station 92, which could result in poor electrical contact between the docking station 92 and the portable unit 90. The quality of the electrical connection may be important in cases where the docking station 92 is configured with a larger, higher quality speaker to improve sound reproduction (or other output, such as an image display). Such speakers may be desirable in cases where the size of the portable unit 90 limits the size of the speaker 108 and, thus, the quality of the audio reproduction. Preventing the portable unit 90 from vibrating while in the docking station 92 also avoids any rattling that would occur, as the housing of the portable unit 90 is displaced laterally within the docking station 92. Such rattling could otherwise constitute a nuisance or noisy distraction from the reproduction of the captured audio. In any case, when the portable unit 90 is removed from the docking station 92, the microprocessor 100 then detects the absence of charging voltage and automatically enables the vibration feature.

If the portable unit 90 is equipped to be charged directly by the power adapter 114 (e.g., the docking station 92 is not required and the power adapter 114 can plug directly into the portable unit 90), it may remain desirable to disable the vibration alert to prevent the portable unit 90 from vibrating. There may be little advantage to using the vibration feature during, for instance, battery recharging sessions, because the user will not be carrying the portable unit 90 when the adapter 114 is plugged in. Instead, the portable unit 90 will likely be disposed on a table, countertop, or in some other desired location near a power outlet. Disabling the vibration feature prevents the unit 90 from “walking off” of the table or other undesirable displacement arising from the vibration. Disabling the vibration feature in these circumstances also avoids wasting power on the vibration motor 118 when a user is not able to detect the resulting vibration. The power saved may then be more usefully directed to charging the batteries of the portable unit 90.

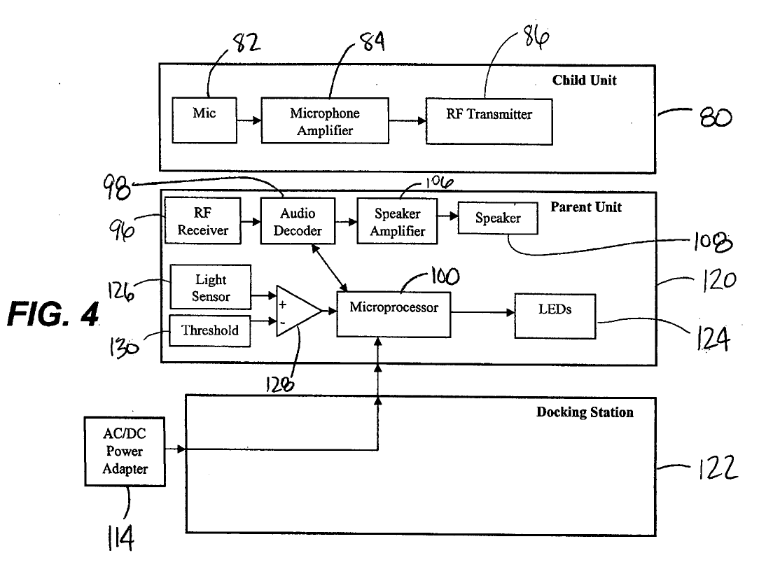

Turning now to FIG. 4, where elements in common with other drawing figures are identified with like reference numerals, a portable unit 120 is configured to engage a docking station 122. Receiver functionality is again controlled in accordance with whether the portable unit 120 and the docking station 122 are engaged. In this example, the brightness or intensity of soundlights and other visual indicators is adjusted or otherwise controlled in accordance with the engagement, and set to a predetermined or otherwise set level without the engagement. Dimming of the soundlights may be useful, for example, when the docking station 122 is located on a nightstand, and the child monitoring is occurring during nighttime hours.

To set the brightness of a light-emitting diode (LED) array 124 or other lamp or light on the portable unit 120, the microprocessor 100 is configured to control brightness based on an input signal supplied by an ambient light sensor 126. In this example, the sensor 126 provides the signal to a comparator 128 (e.g., an op-amp or other analog or digital circuit) responsive to one or more predetermined or user-determined thresholds. The output of the comparator 128 is then provided to the microprocessor 100 to determine the appropriate intensity level. Data indicative of the threshold(s) may be stored in a memory 130. One or both of the comparator 128 and the memory 130 may be integrated with the microprocessor 100 to any desired extent.

The microprocessor 100 (or other receiver electronics component) may then be configured to determine when the above-described automatic brightness control functionality is implemented or applied to control the LED array 124. More specifically, the microprocessor 100 may be configured to implement the LED brightness routine or otherwise allow the brightness to be adjusted based on whether the portable unit 120 is inserted in the docking station 122. This determination may be made, for example, in a manner similar to that described in connection with the embodiment of FIG. 3. That is, the microprocessor 100 may be configured to detect the charging voltage resulting from the engagement, such that the routine is implemented only when the charging voltage is detected (i.e., when the portable unit and the docking station are engaged). The microprocessor 100 may alternatively or additionally determine the brightness level based on the amplitude of the sound captured by the transmitter 80. When the amplitude is high, the brightness may be increased to provide an appropriate indication of activity at the transmitter 80.

In alternative cases, one or more of the components involved in the automatic brightness control functionality may be disposed in or on the docking station 122. For example, the light sensor 126 may be located at a position on the docking station 122 to avoid light spill from the user interface elements of the portable unit 120. In either case, the comparison of the output of the light sensor 126 to the threshold may be performed either in the portable unit 120 or the docking station 122.

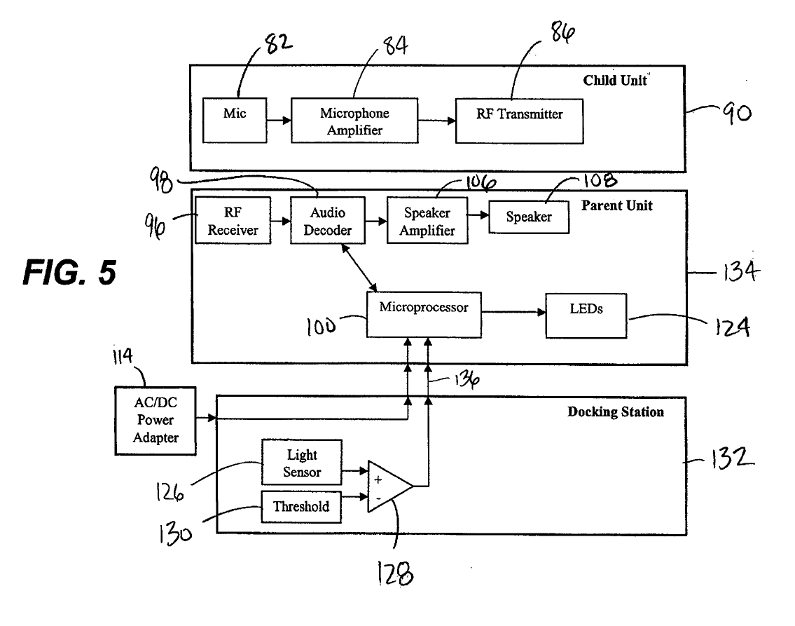

FIG. 5 depicts one such exemplary re-arrangement. In this case, a docking station 132 includes the light sensor 126, the comparator 128, and the threshold information 130. The microprocessor 100 of a portable unit 134 receives the results of the comparison via one or more contacts 136. The functionality may otherwise remain the same. That is, the microprocessor 100 may still control the LED brightness based on the data collected by the light sensor 126 and whether the portable unit 124 is inserted in the docking station 132. For example, when the portable unit 134 is engaged with the docking station 132, the LED brightness is controlled by the ambient light. When the portable unit 134 is removed from the docking station 132, the LED brightness is set to a predetermined (e.g., high) level.

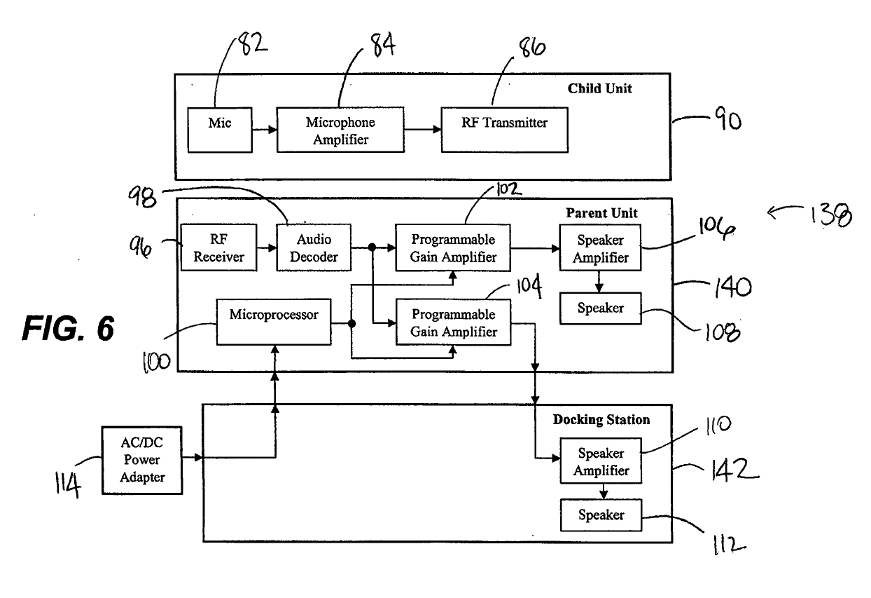

FIGS. 6-11 depict a number of exemplary embodiments in which audio functionality is provided by both portable units and the corresponding docking stations. The techniques and manner in which the audio functionality is shared and addressed by the portable units and the docking stations may be applied to the other features and functionality addressed above.

FIG. 6 shows an exemplary monitoring system 138 having a portable unit 140 and a docking station 142 with audio reproduction functionality distributed and shared in accordance with one aspect of the disclosure. As described above in connection with FIG. 3, the transmitter 90 converts sound into electrical energy with the microphone 82, amplifies the signal with the amplifier 84, and encodes an RF transmission with the audio information. The portable unit 140 receives the RF transmission and decodes the audio information. The programmable gain amplifiers 102, 104 are used to adjust the audio level and are used as volume controls. To support separate adjustments, there are separate programmable gain amplifiers for the speaker amplifiers 106, 110 in the portable unit 140 and the docking station 142. In that way, the volume for the speaker 108 in the portable unit 140 and the speaker 112 in the docking station 142 can be controlled individually. Once the volume levels) are set, the audio information is amplified and sent to the speaker(s) 108, 112 where it is converted into sound.

The microprocessor 100 detects when the portable unit 140 is inserted into the docking station 142 by, for instance, looking for the charging voltage from the docking station 142. When the charging voltage is detected, the microprocessor 100 sends commands to the programmable gain amplifiers 102, 104 to direct a change to a different volume level. In one exemplary case, when the portable unit 140 is inserted in the docking station 142, the programmable gain amplifier 102 is turned off, and the programmable gain amplifier 104 is set to the appropriate volume. When the portable unit 140 is removed from the docking station 142, the programmable gain amplifier 102 is set to the appropriate volume, and the programmable gain amplifier 104 is turned off.

When the user adjusts the volume controls on the portable unit 140 (see, e.g., FIG. 2A), a new volume level is stored in a memory in a non-transient fashion. The volume settings for when the portable unit 140 is inserted in the docking station 142 and removed from the docking station 142 are stored separately.

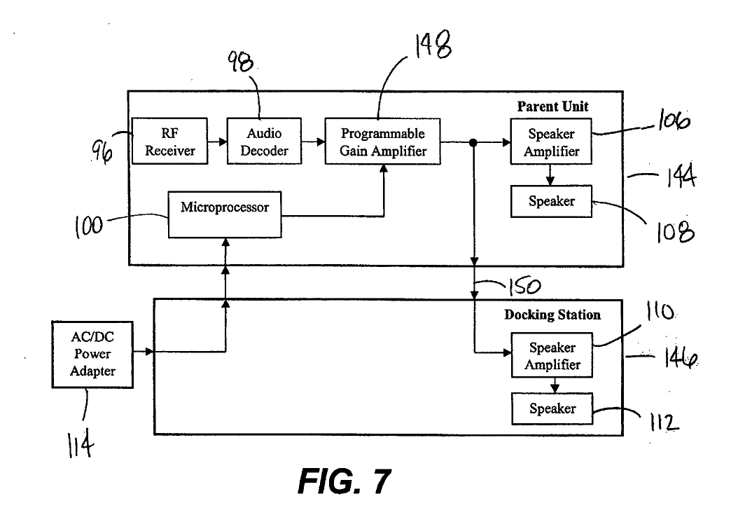

FIG. 7 shows another exemplary portable unit 144 with a docking station 146 having speaker functionality provided via a shared amplifier in accordance with an alternative embodiment. In this example, a programmable gain amplifier 148 is used to adjust the audio volume level for both the portable unit 144 and the docking station 146. The microprocessor 100 sends commands to the programmable gain amplifier 148 to change the volume. The audio information is then amplified and sent to the speaker 108 as described above. The audio information is also sent to the docking station 146 via connectors or contacts 150. In the docking station 146, the audio information is amplified and sent to the speaker 112 as described above.

In this exemplary case, the volume level is controlled based on whether the portable unit 144 and the docking station 146 are engaged. More specifically, the microprocessor 100 again detects when the portable unit 144 is inserted into the docking station 146 by, for instance, looking for the charging voltage from the docking station 146. Once the engagement is detected, the microprocessor 100 sends a command to the programmable gain amplifier 148 to change to a different volume level, which may be user-determined, predetermined, or both.

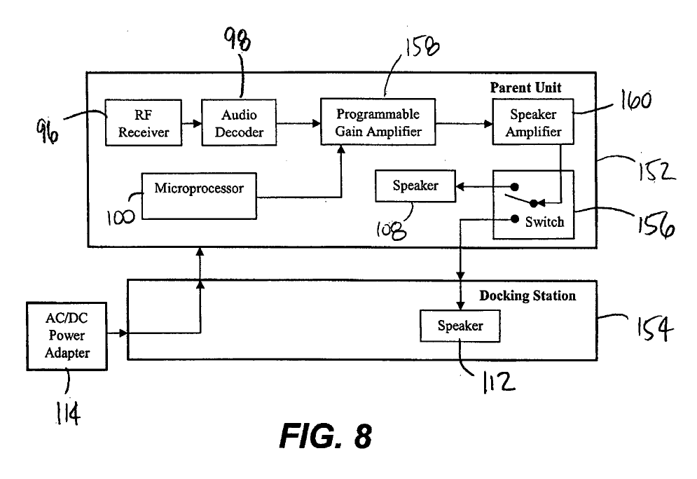

FIG. 8 shows yet another exemplary portable unit 152 and docking station 154 with speaker functionality controlled by a switch 156 in accordance with another aspect of the disclosure. In this example, the speaker 108 in the portable unit 152 is turned off while the speaker 112 in the docking station 154 is activated. De-activating the portable unit speaker 108 may rely on the switch 156 to select the speaker 108 in the portable unit 152 or the speaker 112 in the docking station 154. In some cases, the switch 156 may be actuated mechanically when the portable unit 154 is inserted into the docking station 154. In other cases, the switch 156 may be controlled via the microprocessor 100. More generally, the switch 156 may be configured such that the switch contacts can accommodate switching significant current while still avoiding premature degradation. In this example, only one programmable gain amplifier 158 and one speaker amplifier 160 are utilized.

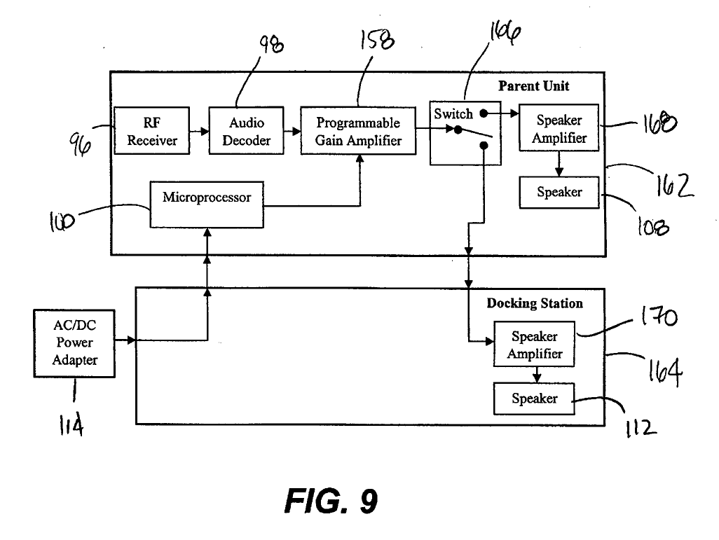

FIG. 9 shows still another exemplary portable unit 162 and docking station 164 with speaker functionality in accordance with an alternative switch-based embodiment. In this example, the speaker 108 in the portable unit 162 is again turned off while the speaker 112 in the docking station 164 is being used. A switch 166 is utilized to select between a speaker amplifier 168 in the portable unit 162 and a speaker amplifier 170 in the docking station 164. The switch 166 may be actuated mechanically when the portable unit 162 is inserted into the docking station 164. Alternatively, the switch 166 may be an electronic switch controlled, for instance, by the microprocessor 100.

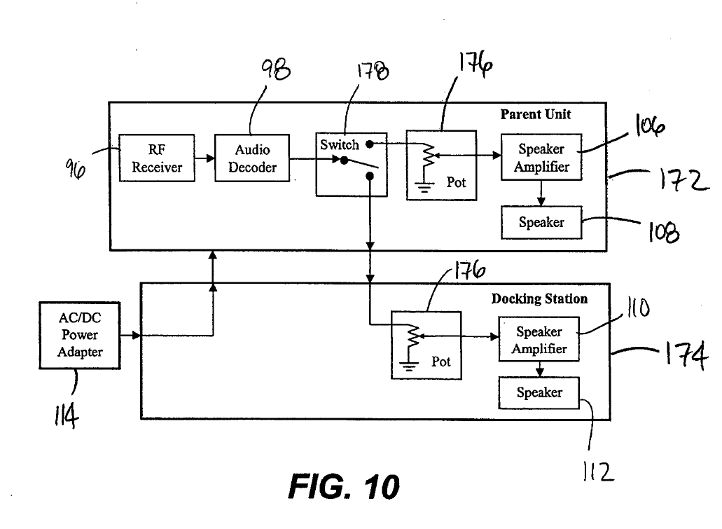

FIG. 10 shows an exemplary portable unit 172 and docking station 174 with speaker functionality provided via one or more potentiometers 176. In this example, the potentiometers 176 are used to adjust the volume, and a switch 178 is used to select the speaker amplifier 106 in the portable unit 172 or the speaker amplifier 110 in the docking station 174. The switch 178 may be take any mechanical or electrical form, and be configured to detect the engagement of the portable unit 172 and the docking station 174, as described above. This exemplary embodiment may use very low cost components, and no microprocessor is required for controlling volume or switching.

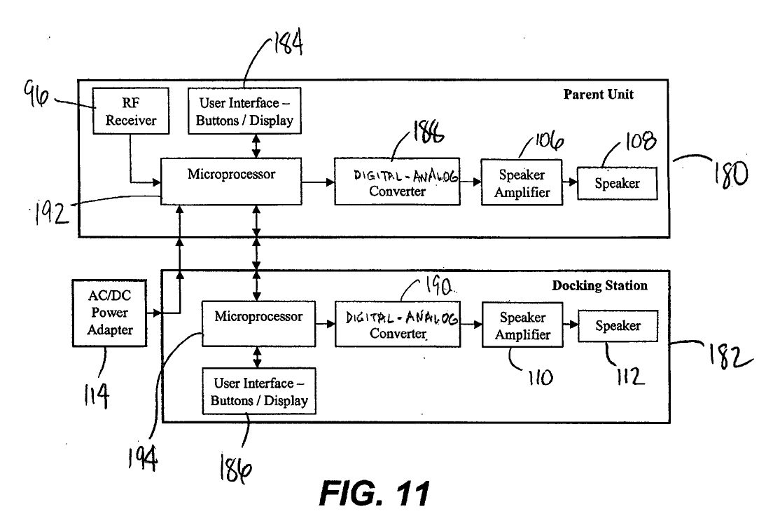

FIG. 11 shows an exemplary portable unit 180 and docking station 182 with speaker functionality controlled via respective user interface elements 184, 186 and corresponding microprocessor communications. In this example, audio information is transmitted to the receiver digitally. Respective digital-to-analog converters 188, 190 in the portable unit 180 and the docking station 182 convert the digital information into analog audio signals for the speaker amplifiers 106, 110. In this embodiment, commands generated from switches or other controls driven by the user interface elements 184, 186 (e.g., buttons or other toggle switches, touch screen elements, etc. actuated or selected by the user) may be passed between microprocessors 192, 194 of the portable unit 180 and the docking station 182, respectively. The switches or other interface elements 184, 186 may control a host of features or other aspects of the docking station 182 and the portable unit 180, including, for instance, the activation and de-activation of user interface lights, audio functionality, etc. One or both of the microprocessors 192, 194 may also be configured to implement one or more of the detection and feature control routines based on whether the portable unit 180 and the docking station 182 are engaged. This configuration may minimize the number of electrical connections between the portable unit 180 and the docking station 182, while supporting a high level of functionality.

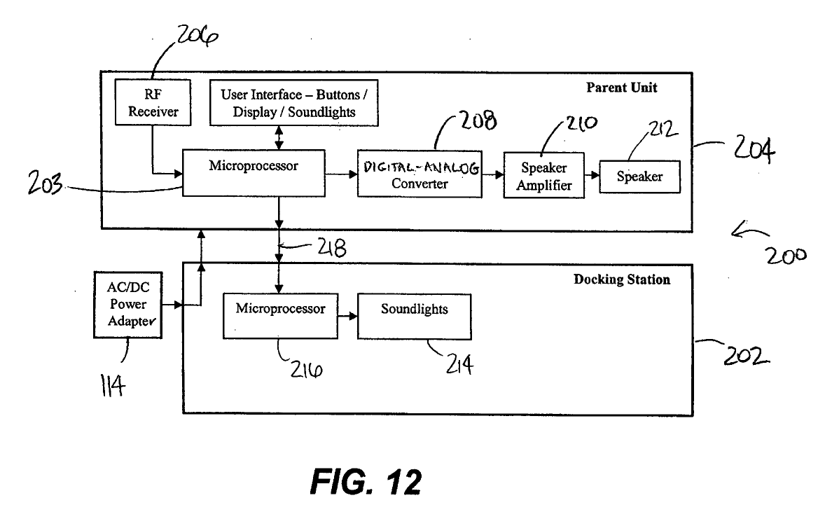

With reference now to FIG. 12, a receiver indicated generally at 200 is configured to provide soundlight functionality in a docking station 202. In this case, a microprocessor 203 in a portable unit 204 of the receiver 200 examines the audio information collected from an RF signal received by electronics 206. The microprocessor 203 is configured to determine the amplitude of the audio signal and generate a digital representation thereof. The digital representation may be used to support both audio reproduction and soundlight functionality. More specifically, the digital representation may be converted via an digital-to-analog converter 208 into an analog representation suitable for use by a speaker amplifier 210 coupled to a speaker 212 of the portable unit 204. The digital representation may also be provided to the docking station 202 to support the illumination of soundlights 214 for a suitable visible indicator of the volume level. To this end, the docking station 202 may include a further microprocessor 216 coupled to contacts or connectors 218 to receive commands from the microprocessor 203.

Relying on the soundlights 214 of the docking station 202 may address shortcomings arising from a small form factor portable unit. Any soundlights on the portable unit 204 may, as a result, be much simpler or smaller than the arrangement of the soundlights 214 on the docking station 202. In some cases, the portable unit 204 may include only a single light. As a result, the soundlight output of the portable unit 204 may be disabled or otherwise controlled via the techniques described above based on whether the portable unit 204 and the docking station 202 are engaged. Either one or both of the microprocessors 203 and 206 may be involved in the implementation of the detection and feature control aspects of the techniques.

In an alternative embodiment, the audio amplitude information may be sent digitally to the docking station 202 to support the soundlight functionality. For example, the microprocessor 216 in the docking station 202 may be configured to examine the audio amplitude information to determine the soundlight control signals.

Alternatively, the microprocessor 203 in the portable unit 204 drives the soundlights 214 in the docking station 202 directly. In such cases, additional contacts may be provided between the portable unit 204 and docking station 202 to accommodate the drive signals.

Soundlights in the above-described docking stations may be implemented in a variety of ways in connection with the foregoing embodiments. For instance, the actual audio signal may be passed to the docking station, and a bar graph driver integrated circuit (e.g., National Semiconductor LM3914) may then drive the soundlights.

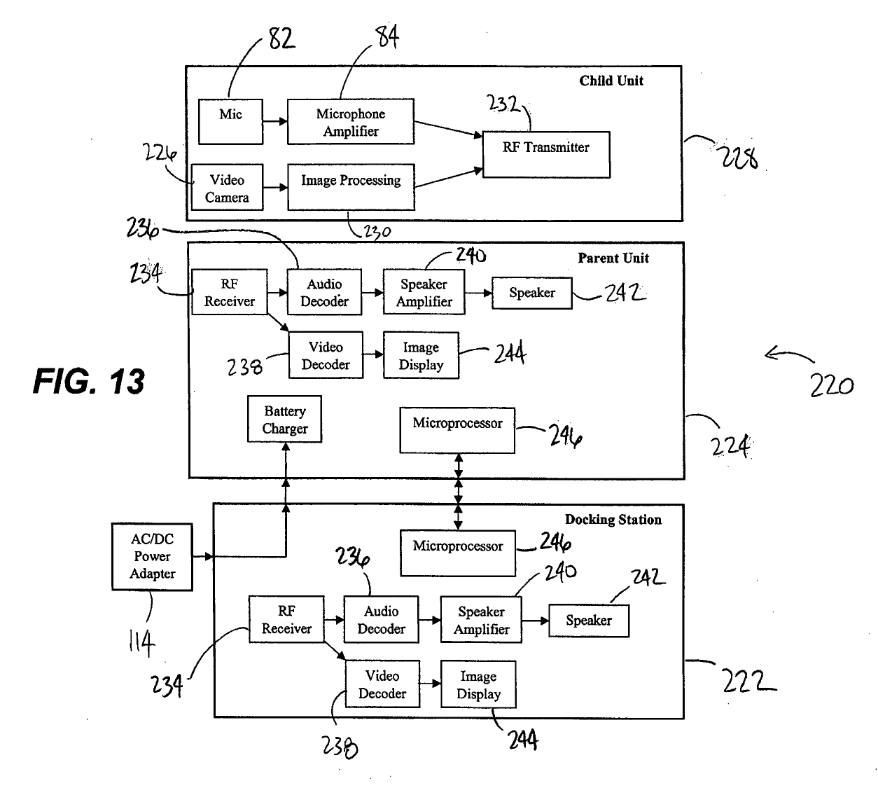

Turning now to FIGS. 13-15, a number of examples are described in which video or image functionality is addressed by portable units and docking stations of a receiver. As with the embodiments described above, the video or image output of the receiver is generally altered or otherwise controlled based on whether the portable unit and docking station are engaged. In some cases, the audio output may be controlled in conjunction with the video or image output.

FIG. 13 depicts an exemplary monitoring system indicated generally at 220 in which video monitoring functionality is provided via both a receiver docking station 222 and a receiver portable unit 224. At the outset, video information is captured by a video camera 226 of a transmitter 228. Image processing electronics 230 compress and otherwise prepare the captured video information for transmission via an RF transmitter 232.

In this example, audio and video reproduction by the receiver 220 are handled in the same manner, e.g., collectively. Generally speaking, when the portable unit 224 is inserted in the docking station 222, both audio and video reproduction by the portable unit 224 are disabled or stopped via any of the above-described detection and control techniques. When the portable unit 224 is removed from the docking station 222, the video and audio playback in the portable unit 224 is enabled. The video and audio playback in the docking station 222 can continue or can be automatically turned off based on, for example, a user switch or setting.

To those ends, both the portable unit 224 and the docking station 222 include an RF receiver 234, an audio decoder 236, and a video decoder 238. These components of the portable unit 224 and the docking station 222 may be similar, if not identical, insofar as the other components downstream from, or driven by, these components may be similar, if not identical. For instance, the portable unit 224 and the docking station 222 may, but need not, include similar speaker amplifiers 240, speakers 242, image display apparatus 244, and microprocessors 246. However, those components on the docking station 222 may be larger and therefore present a larger electrical load, and otherwise not be encumbered by the size limitations of the portable unit 224.

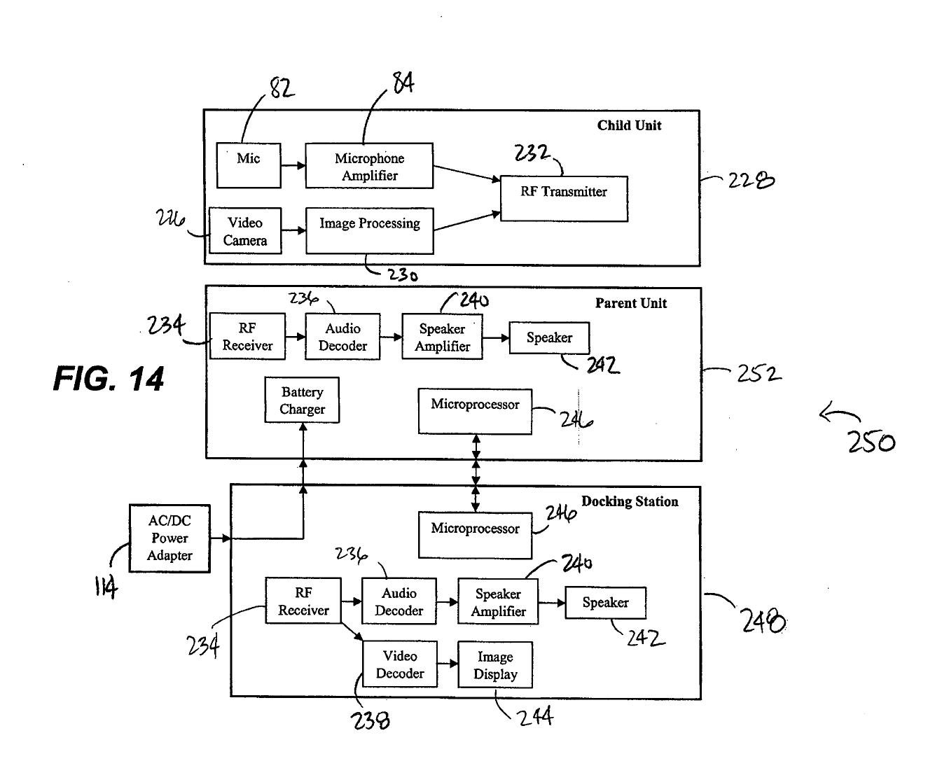

The example of FIG. 14 differs from the preceding case in the sense that only a docking station 248 of a receiver 250 provides video functionality. That is, the docking station 248 includes the above-described components to support video monitoring output, while a portable unit 252 includes only those components involved in audio output. The portable unit 252 is therefore configured such that audio reproduction is stopped upon engagement with the docking station 248. The docking station 248, in turn, may be configured such that, upon engagement, video and audio playback in the docking station 248 is started. When the portable unit 252 is removed from the docking station 248, the audio playback in the portable unit 252 is enabled. The video and audio playback in the docking station 248 can then continue or can be automatically turned off depending on, for instance, a user setting or switch.

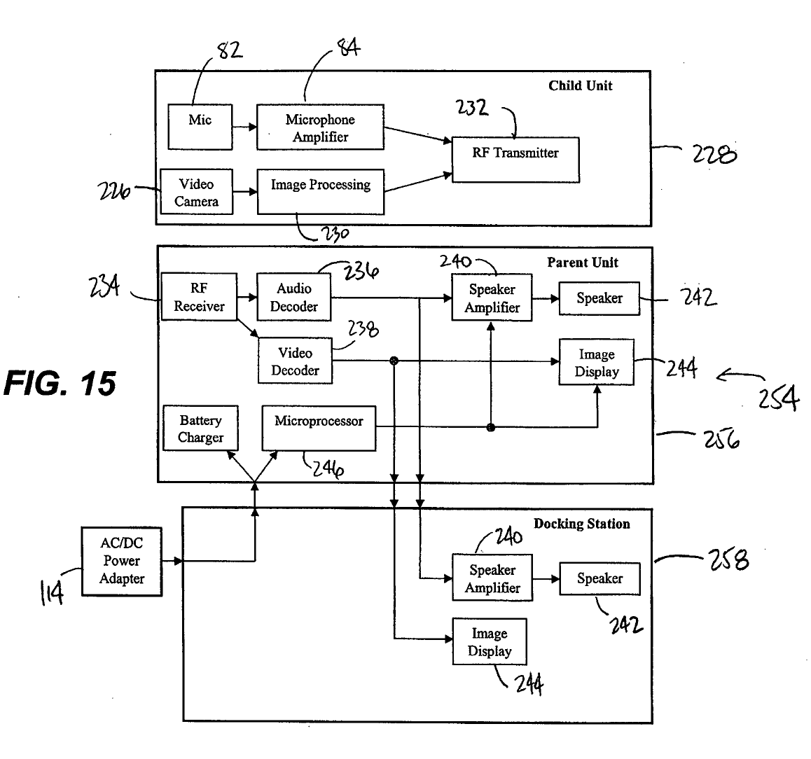

FIG. 15 depicts yet another example in which video reproduction functionality is supported across a docking station/portable unit arrangement. In this case, a receiver indicated generally at 254 includes a portable unit 256 configured to support video monitoring for both itself and a docking station 258. The docking station 258 may, but need not, have a larger screen and larger speaker than the corresponding components in the portable unit 256. In any case, the audio and video output from the portable unit 256 are disabled when the portable unit 256 is inserted in the docking station 258. When the portable unit 256 is removed from the docking station 258, audio and video playback in the portable unit 256 is then enabled.

Described above are baby monitoring systems with a docking station for a portable unit of a receiver to provide functionality for which the portable unit may be less well suited. Generally speaking, the disclosed systems address the complications and challenges arising from reductions in the size of the portable unit. Other aspects of the disclosed systems involve the docking station providing features or functions not typically provided by a portable unit.

The following summary outlines examples of output functions and features that may be distributed between the docking stations and portable units in accordance with the control techniques described herein.

Speaker(s)—This feature involves one or more enhanced (e.g., larger) speakers in the docking station. This allows for higher volume and higher quality sound when the portable unit is inserted in the dock. In some cases, the portable unit detects when it is inserted in the dock, and automatically enables the speaker in the docking station. The speaker in the portable unit may, but need not, be turned off at the same time.

Volume Adjustment and/or Customization—This feature may provide a separate or distinct volume level when the portable unit is inserted in the dock. For example, the volume may be at one level when the caregiver is carrying the portable unit, and at a different level when the portable unit is inserted into the docking station. In some cases, the portable unit detects when it is inserted into the docking station, and automatically changes to a different sound level. The portable unit may be configured with a volume control interface, which may then be used to adjust the volume of the portable unit speaker or the dock speaker. Alternatively or additionally, volume controls are placed on the docking station. The two volume levels may be stored in permanent or other non-transient memory in the portable unit or the docking station.

Docking Station Soundlights—The docking station may include an arrangement of soundlights having a configuration not as well-suited for a smaller sized portable unit. For instance, the dock may contain a traditional linear array of soundlights, while the portable unit contains only a single light. In some cases, the portable unit detects when it is inserted in the dock, and automatically turns off the portable unit soundlights and turns on the dock soundlights.

Docking Station Lighting—The docking station may include lighting that illuminates the docking area under certain circumstances, such as when the portable unit is removed. This can help the user locate the docking station in a darkened room. In some cases, the lighting fades in and out slowly or be otherwise varied or adjustable, as desired (e.g., to give the unit a more organic appearance). The docking station may have any number of user interface elements (e.g., buttons) to control one or more corresponding features, such as volume or brightness. The brightness adjustment may apply selectively or collectively to a video monitor, soundlight set, and other interface lights (e.g., LEDs).

Soundlight Dimming—The soundlights disposed on the portable unit and/or the docking station may dim when the portable unit is inserted in the docking station. The docking station is often placed on a nightstand and used at night in a dark room. In these and other cases, the soundlights on the portable unit may be bright for normal daytime use, and dimmed when using the docking station at night. To this end, the portable unit or the docking station may include an ambient light sensor or other component (e.g., clock, timers, etc.) to switch between bright, dimmed and other desired levels or modes.

Video Monitors—The system may include one or more video monitors. A monitor on the docking station may include a larger video screen relative to the video screen disposed on a small portable unit configured for portability. In this way, the system may be configured such that an image (i.e., a larger image) is displayed via the docking station (rather than the portable unit) when the portable unit is inserted in the docking station. In some cases, the docking station includes a video monitor that can operate independently of the portable unit.

Components of the disclosed systems, devices, and methods may be implemented in hardware, firmware, software, or any combination thereof. Some embodiments may be implemented as computer programs executing on programmable systems comprising at least one processor, and a data storage system (including volatile and non-volatile memory and/or storage elements). For purposes of this application, any processor includes any device or system that includes any number of processors or processing elements, such as, for example, a digital signal processor (DSP), a microcontroller, an application specific integrated circuit (ASIC), or a microprocessor.

The programs may be implemented in any programming language to communicate with the processors described herein. The programs may also be implemented in assembly or machine language, if desired. In fact, practice of the disclosed system and method is not limited to any particular programming language or programming technique. In any case, the language may be a compiled or interpreted language.

The programs may be stored on any type and number of storage media or devices (e.g., read only memory (ROM), flash memory device, etc.) readable by a general or special purpose programmable processor, for configuring and operating the processor when the storage media or device is read by the processor to perform the procedures described herein. The storage media or devices may, but need not, be integrated with the processors described herein. Embodiments of the disclosed systems, devices, and methods may also be considered to be implemented as a machine-readable storage medium, configured for use with a processor, where the storage medium so configured causes the processor to operate in a specific and predefined manner to perform the functions described herein.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

The foregoing description is given for clearness of understanding only, and no unnecessary limitations should be understood therefrom, as modifications within the scope of the invention may be apparent to those having ordinary skill in the art.

Although certain systems, devices and techniques have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A child monitoring system comprising:
a transmitter configured to capture information and transmit a signal indicative of the captured information; and
a receiver configured to receive the signal and to generate an output in accordance with the captured information, the receiver comprising a portable unit and a docking station configured to engage the portable unit;
wherein the receiver comprises a detector configured to determine whether the portable unit and the docking station are engaged, and wherein the receiver further comprises a processor configured to control generation of the output in accordance with whether the portable unit and the docking station are engaged.

2. The child monitoring system of claim 1, wherein the detector is configured to detect a charging voltage from the docking station to determine whether the portable unit and the docking station are engaged.

3. The child monitoring system of claim 1, wherein the processor comprises the detector.

4. The child monitoring system of claim 1, wherein the portable unit comprises a vibration motor such that the output comprises a vibration alert generated via the vibration motor, and wherein the processor is configured to disable the generation of the vibration alert when the portable unit and the docking station are engaged.

5. The child monitoring system of claim 1, wherein the portable unit comprises a user interface light for which illumination is controlled by the processor such that the output comprises a visual indication via the user interface light.

6. The child monitoring system of claim 5, wherein the processor is configured to disable the generation of the visual indication when the portable unit and the docking station are engaged.

7. The child monitoring system of claim 5, wherein the receiver further comprises a light sensor configured to generate an indication of an ambient light level for the receiver, and wherein the processor is configured to adjust an illumination intensity of a user interface light based on the ambient light level indication when the portable unit and the docking station are engaged.

8. The child monitoring system of claim 5, wherein the portable unit comprises the light sensor.

9. The child monitoring system of claim 5, wherein the docking station comprises the light sensor.

10. The child monitoring system of claim 1, wherein the captured information comprises audio information, wherein the portable unit comprises a speaker for reproduction of the audio information, and wherein the processor is configured to disable the reproduction of the audio information when the portable unit and the docking station are engaged.

11. The child monitoring system of claim 1, wherein the captured information comprises video information, wherein the portable unit comprises an image display for reproduction of the video information, and wherein the processor is configured to disable the reproduction of the video information when the portable unit and the docking station are engaged.
